(19) United States
(12) Patent Application Publication
(10) Pub. No.: US 2007/0289793 A1
(43) Pub. Date: Dec. 20, 2007

(54) Energy recovery system

(76) Inventor: Imad Mahawili, Grand Haven, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 11/454,948

(22) Filed: Jun. 16, 2006

(51) Int. Cl. B60K 25/10

(52) U.S. Cl. 180/165

(57) ABSTRACT

An energy recovery system including a device that produces a magnetic field, which is adapted for mounting to a vehicle, and a stationary conductor adapted for placing in or adjacent the path of the vehicle wherein the magnetic field induces current to flow through the conductor when the vehicle moves past the conductor. The device is adapted to move between an operative position in close proximity to the stationary conductor and a stowed position further away from the stationary conductor.

The present invention relates to a system and apparatus that recovers energy from a moving object, such as a vehicle.

Energy consumption of non-renewable resources and the pollution created by this energy consumption, as well as pollution created when energy is generated, has long been a concern. Efforts to curb consumption of non-renewable energy sources and to increase efficiency, for example in vehicles, has led to the development of electric and/or hybrid vehicles. While electric and hybrid vehicles have reduced the consumption of some non-renewal resources and generate less pollution, the use of electric vehicles, which require recharging, simply shifts or reallocates the location of the pollution between vehicles and power plants—typically coal fired power plants—and, further, shifts at least some of the energy consumption from one non-renewable source to another non-renewable source-such as from gasoline to coal. However, the total amount of energy consumed by both types of vehicles has remained generally unchanged.

While great strides have been made to increase the energy efficiency of vehicles, there are still inherent energy inefficiencies and thermodynamic Carnot cycle limitations and waste that are not currently addressed. For example, when a vehicle comes to a full stop from any speed or is driven down a hill or an incline, energy is wasted because it is not recoverable at present.

Consequently, there is a need for a system that can recover wasted energy, such as from a vehicle, and further that can covert the wasted energy into a source of useable energy for immediate or later use.

### SUMMARY OF THE INVENTION

Accordingly, the present invention provides an energy recovery system that recovers energy from a moving object, such as a vehicle, which can be used or stored for later use.

In one form of the invention, an energy recovery system includes a magnet that produces a magnetic field, which is adapted for mounting to a vehicle, and a stationary conductor that is adapted for placing in or adjacent the path of the vehicle such that the magnetic field induces current to flow through the conductor when the vehicle moves past the conductor, which is harnessed and stored for immediate or later use. The magnet is mounted in a housing that is adapted to mount to the vehicle and, further, adapted to move between an operative position in relatively close proximity to the stationary conductor and a retracted position closer to the vehicle to reduce the likelihood of impact between the housing and road surface on which the vehicle is traveling.

In one aspect, the system includes a sensor and a driver mechanism for selectively moving the housing between the operative and stowed positions. The sensor senses when the vehicle is in close proximity to the conductor and, further, generates a signal to the driver mechanism to move the housing to the operative position when the sensor senses the vehicle is in close proximity to the conductor.

Optionally, the housing includes a second driver mechanism for selectively retracting the magnet into the housing.

In another aspect the magnet comprises an electromagnet, with the vehicle optionally including a control for actuating the electromagnet. In addition the vehicle may include a sensor, which senses when the vehicle is in proximity to the stationary conductor and, further, generates an actuating signal to the control for actuating the electromagnet.

In yet another aspect, the stationary conductor comprises a plurality of loops of conductive wires. For example, the loops of conductive wires may be mounted about a frame with an upper raceway and a lower raceway that are separated by a magnetic shield, such as a metal shield. For example, the frame may comprise a generally H-shaped frame, which defines the upper and lower raceways.

In another form of the invention, an energy recovery system includes a vehicle, a device for producing a magnetic field, which is mounted to the vehicle, and a circuit. The circuit includes a stationary conductor adapted for placing in the path of the vehicle when the vehicle is moving wherein the magnetic field induces current to flow through the circuit when the vehicle passes by the conductor. The device is configured to move between an operative position wherein the magnetic field is in close proximity to the circuit and a stowed position wherein the device is moved closer to the vehicle.

In one aspect, the conductor comprises a plurality of loops of conductive wires. For example, the conductive wires may be arranged to form a DC circuit or an AC circuit. In a further aspect, the wires are mounted in a frame. Further, the frame is configured for being mounted in a road surface. Alternately, the wires may be mounted in a slab of material, such as concrete or other durable material, which is configured for being mounted in a road surface.

In other aspects, one group of the loops may be arranged to define a passageway, such that when the vehicle passes through the passageway the magnetic field induces current flow through one group of wires.

In yet another aspect, the conductor may be coupled to a load controller and/or an energy storage device.

In another form of the invention, a method of recovering energy includes movably mounting a magnetic field generating device to a vehicle, providing a stationary conductor either in the path of the vehicle or adjacent the path of the vehicle, and moving the magnetic field generating device between an operative position when the vehicle is in close proximity to the conductor and a stowed position wherein the magnetic field generates current flow in the conductor when the vehicle travels past or over the conductor.

In one aspect, the conductor is coupled to an energy storage device, a transmission system, or an energy conversion system so that the energy recovered from the vehicle can be used separate from the vehicle.

In another aspect, the stationary conductor is located in a road surface.

According to yet another aspect, a sensor and a driver mechanism for moving the magnetic field generating device between an operative position wherein the magnetic field generating device is in proximity to the stationary conductor and a stowed position further away from the stationary conductor are provided. The sensor senses when the vehicle is in proximity to the conductor and actuates the driver mechanism to move the magnetic field generator to the operative position when the sensor detects that the vehicle is in proximity to the conductor.

In a further aspect, the magnetic field generating device is housed in a housing, with the housing mounted to the vehicle.

Accordingly, it can be understood that the energy recovery system of the present invention can recover energy from a moving object, such as a vehicle, to convert the energy, which would otherwise be wasted energy, into an energy supply for immediate or later use.

These and other objects, advantages, purposes, and features of the invention will become more apparent from the study of the following description taken in conjunction with the drawings.

### DETAILED DESCRIPTION OF THE DRAWINGS

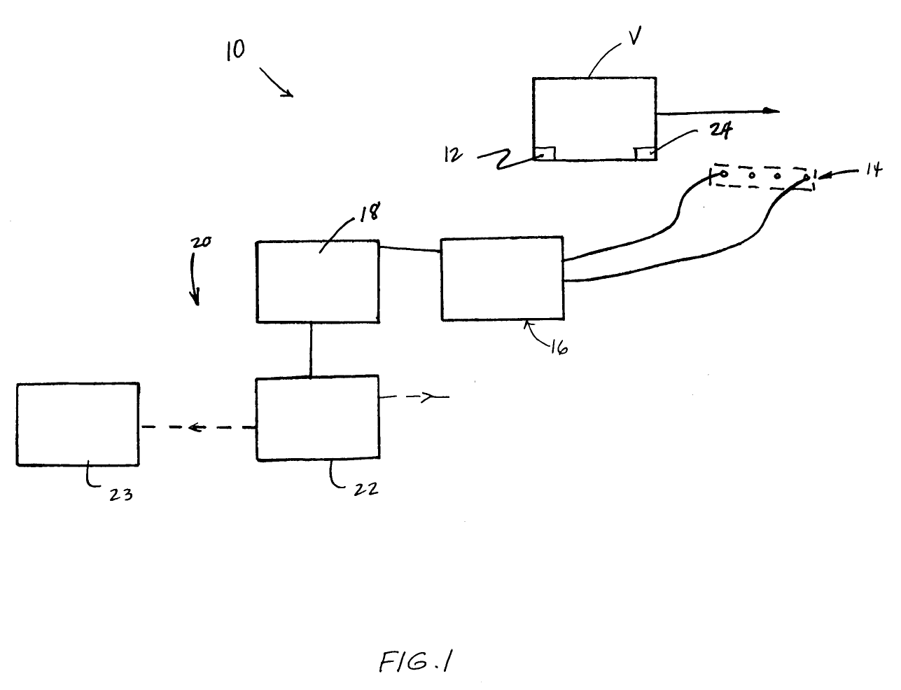

FIG. 1 is a schematic drawing of the energy recovery system of the present invention;

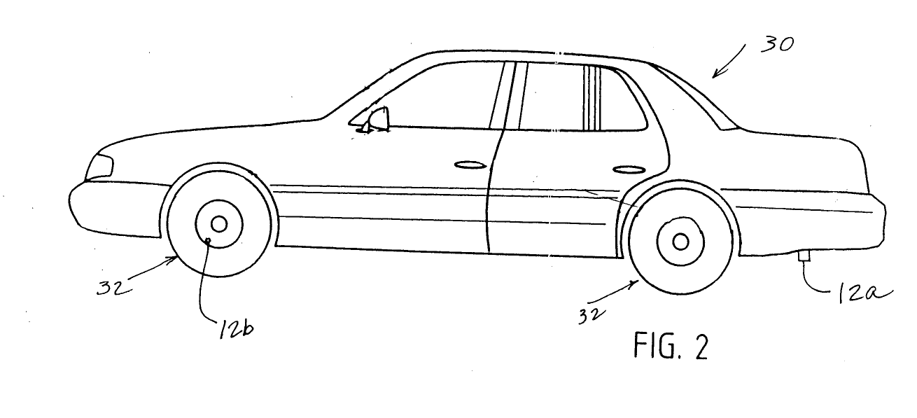

FIG. 2 is a schematic view of the mounting an electromagnetic field generator on a vehicle;

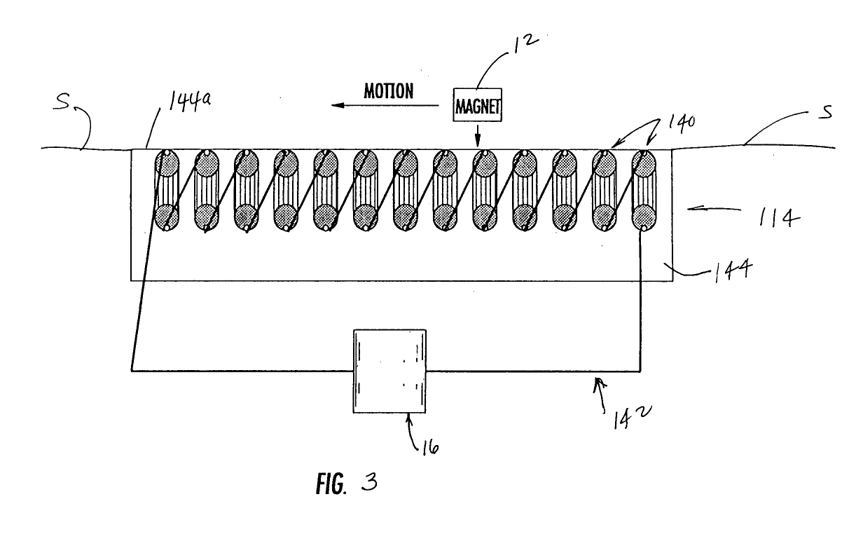

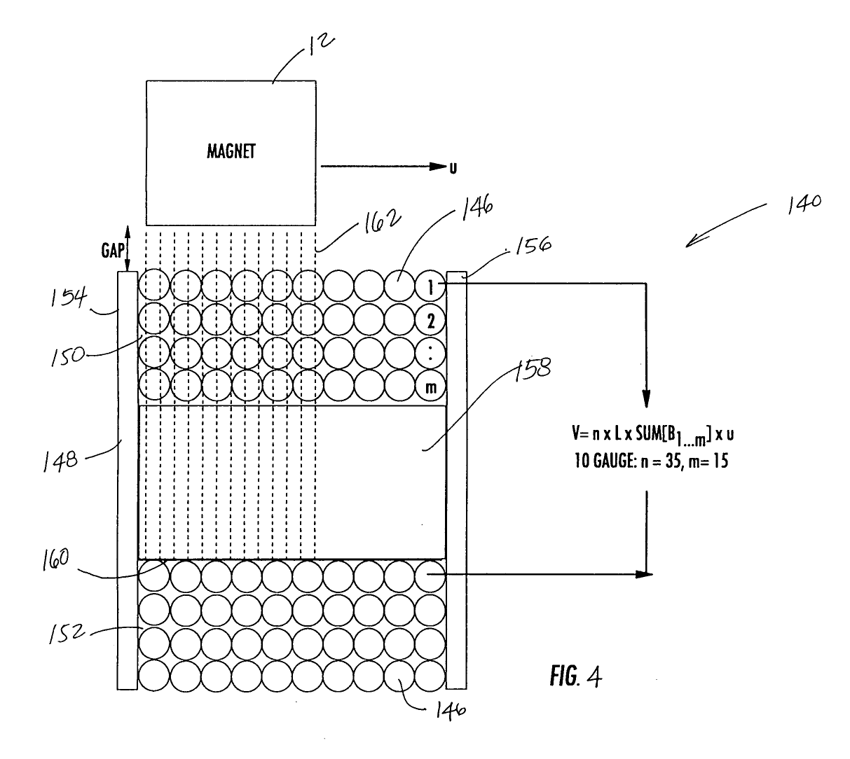

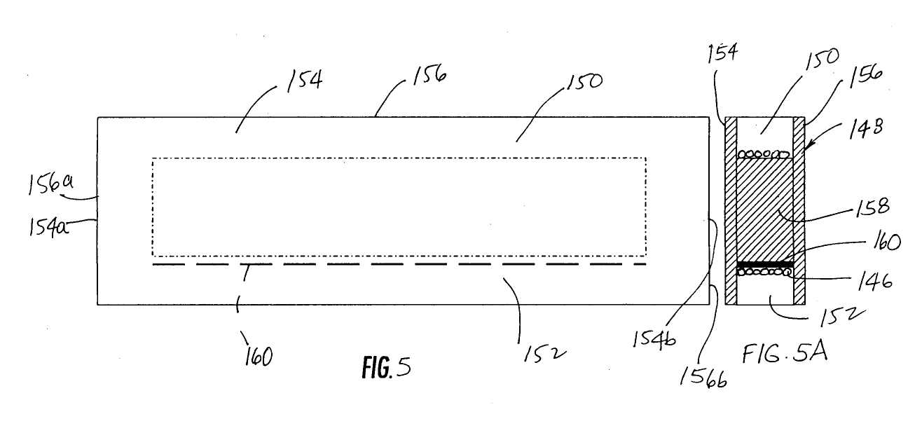

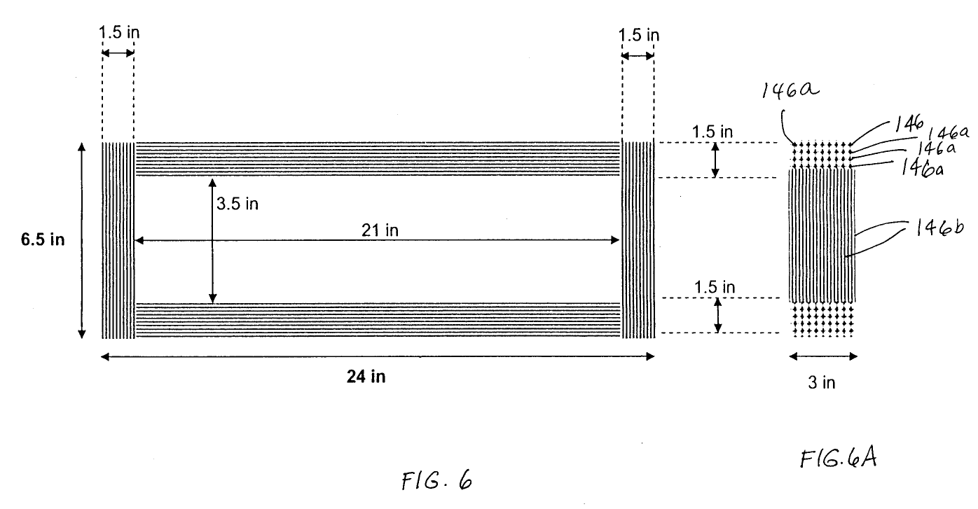

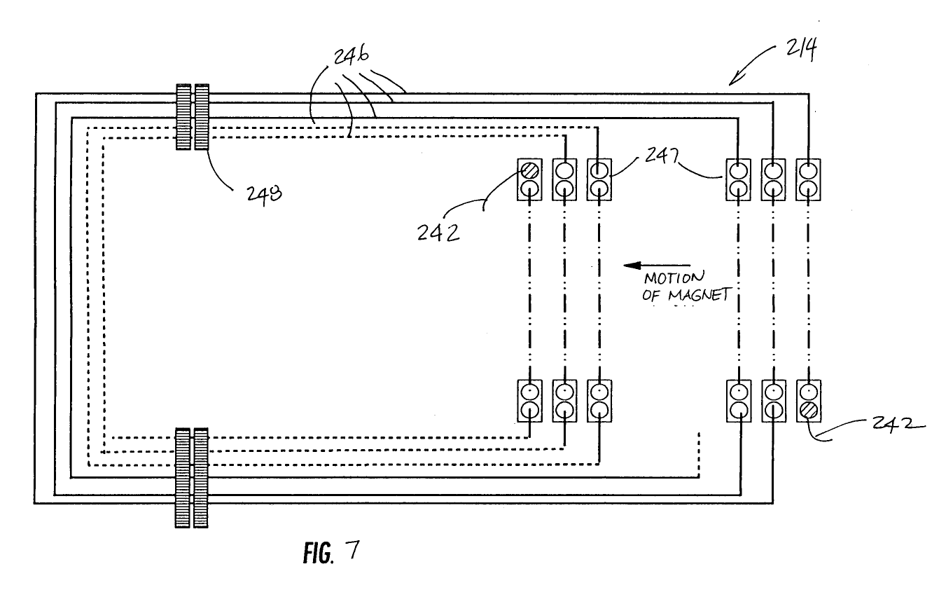

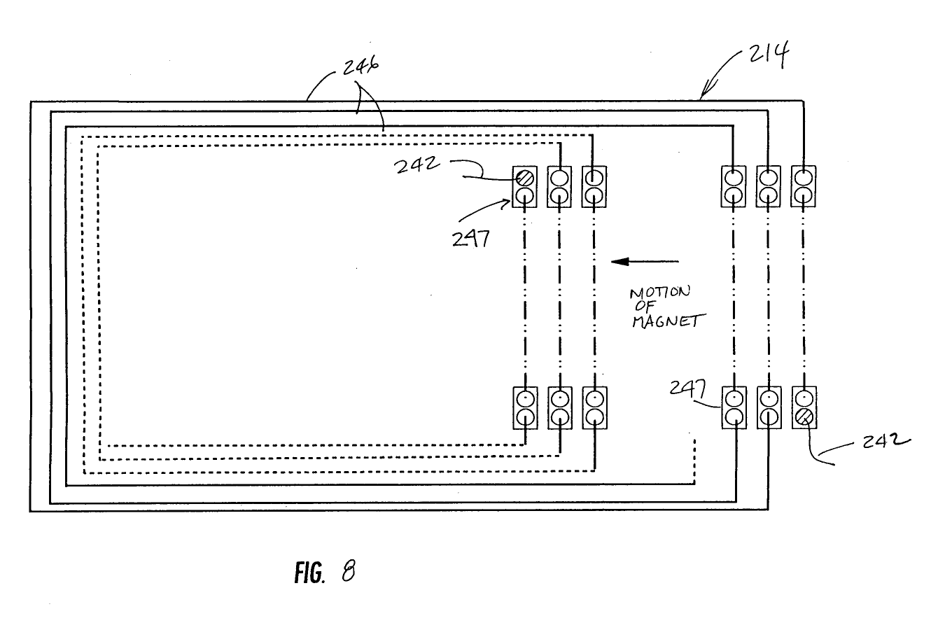

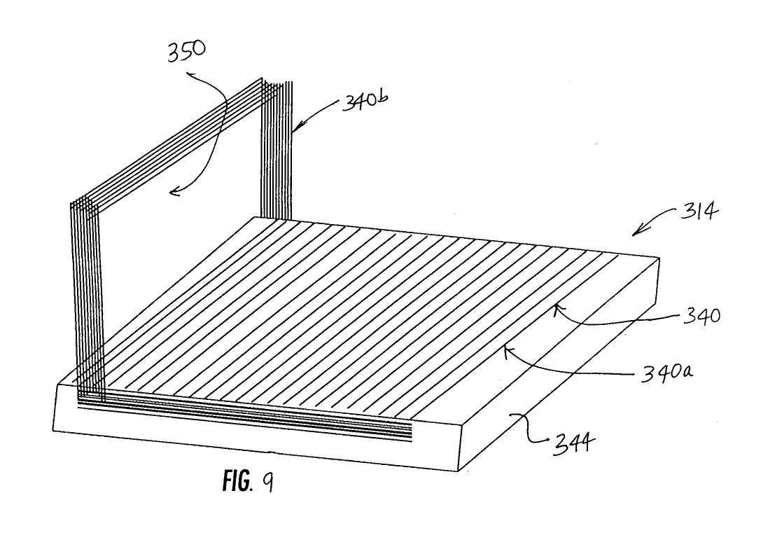

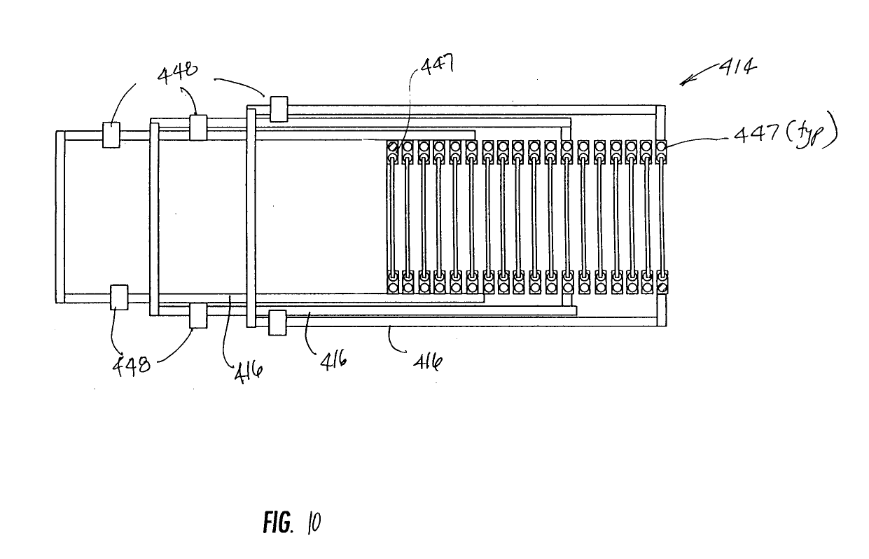

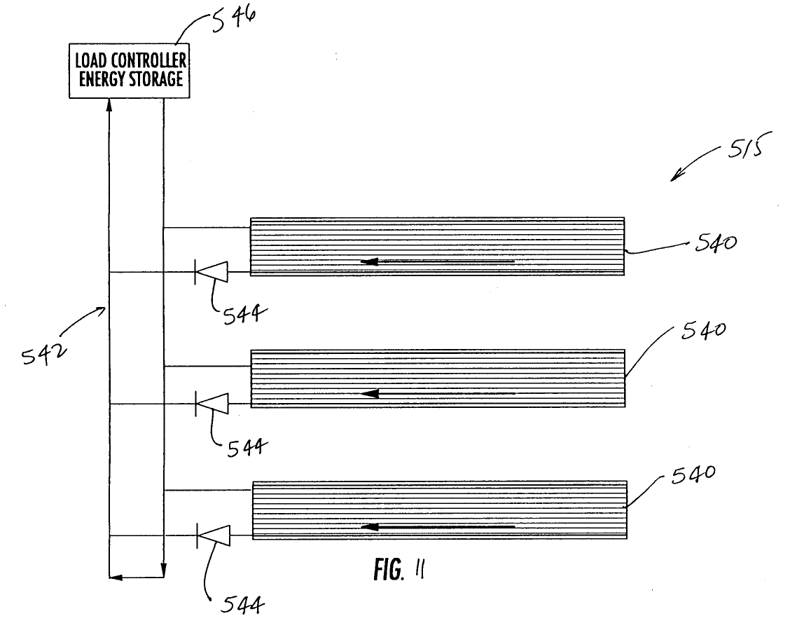

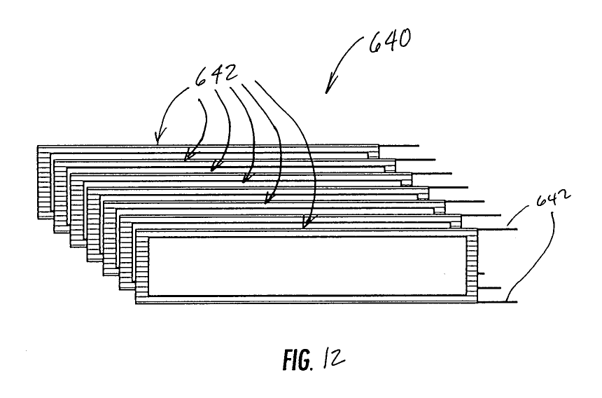

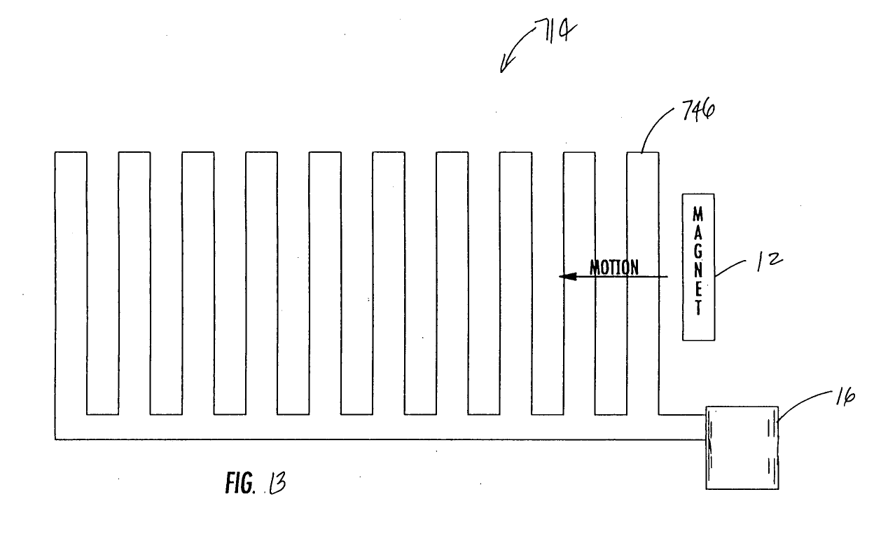

FIG. 3 is a schematic view of one embodiment of a conductor module of the present invention;

FIG. 4 is a schematic cross-section of another embodiment of the conductor module of the present invention;

FIG. 5 is a side view of the module of FIG. 4;

FIG. 5A is an end view of the module of FIG. 5 with the wires partially removed for clarity;

FIG. 6 is a side view of the wires of the conductor module of FIG. 4 with the housing removed for clarity;

FIG. 6A is an end view of the wire bundle of FIG. 6;

FIG. 7 is a schematic view of another embodiment of the conductor in the form of a plurality of looped wires arranged to provide a DC circuit;

FIG. 8 is a similar figure to FIG. 7, with the wire connectors removed for clarity;

FIG. 9 is yet another embodiment of a conductor formed from a plurality of wires arranged in a DC circuit and with one group of wires arranged to form a passageway;

FIG. 10 is yet another embodiment of the conductor of the present invention formed from a plurality of looped wires also arranged in a DC circuit;

FIG. 11 is a schematic view of another embodiment of the conductor of the present invention formed from a plurality of conductor modules that are coupled to a load controller through diodes to form a DC circuit;

FIG. 12 is a perspective view of a conductor module formed a plurality of sub-modules arranged in a plane;

FIG. 13 is a schematic view of another embodiment of the conductor of the present invention comprising a plurality of looped wires that are arranged to form a AC circuit;

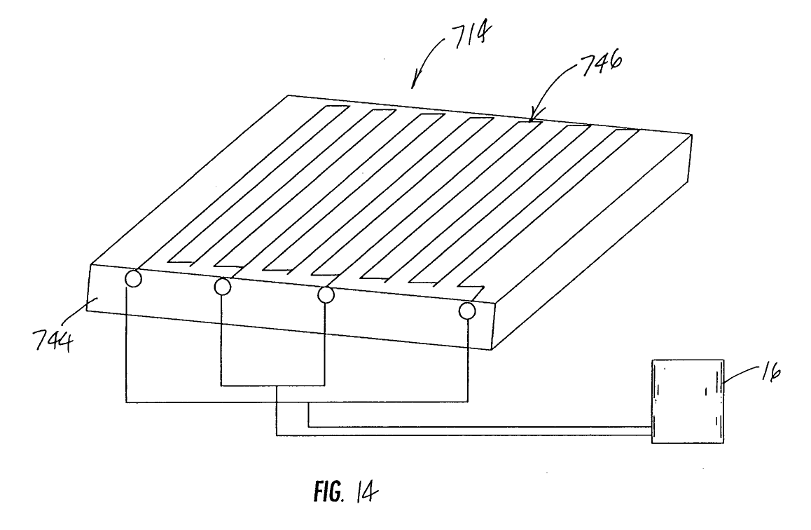

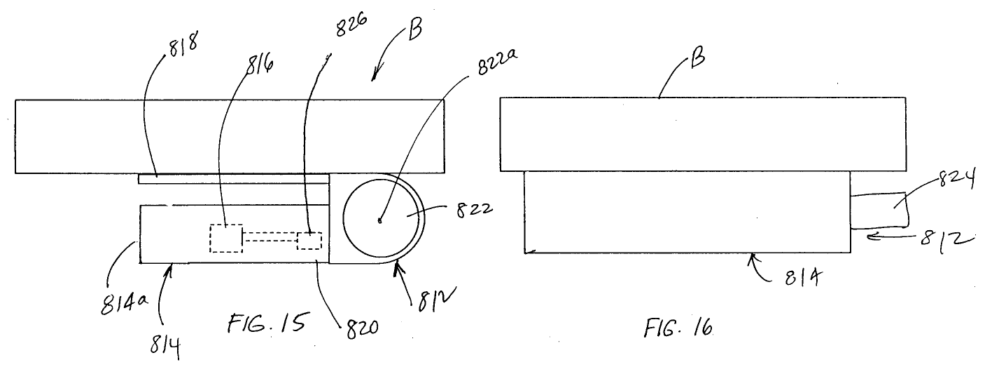

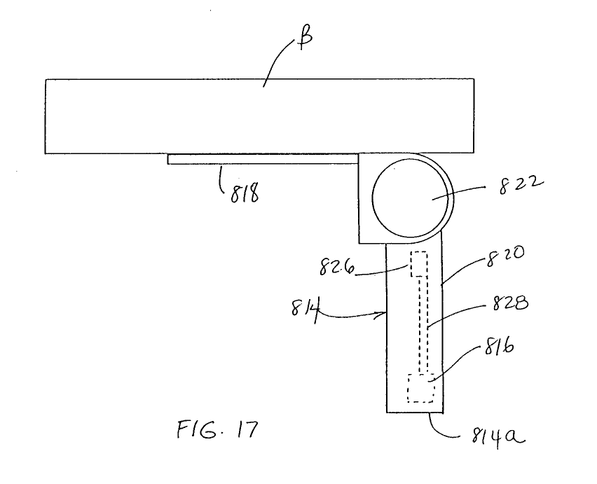

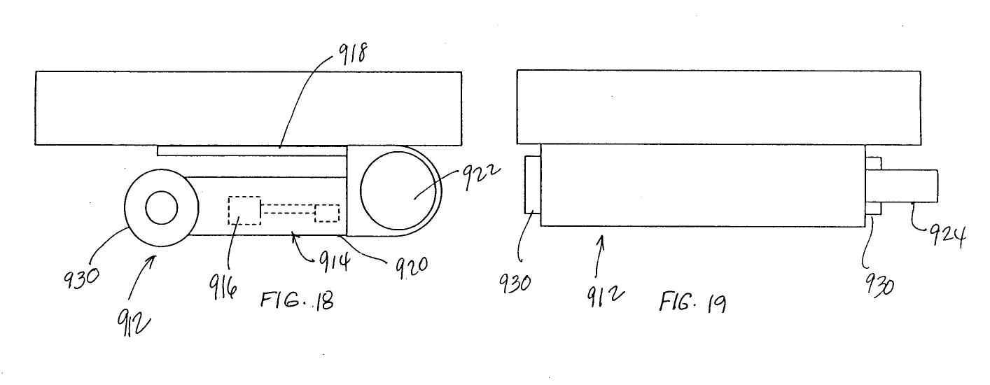

FIG. 14 is another embodiment of an AC circuit of the conductor of the present invention incorporated into a slab;

FIG. 15 is a side elevation view of a magnetic generating device assembly of the present invention;

FIG. 16 is an end view of the magnetic field generating device assembly of FIG. 15;

FIG. 17 is a similar view to FIG. 15 with the assembly housing moved to an operative position;

FIG. 18 is a side elevation view of another embodiment of a magnetic field generating device assembly;

FIG. 19 is an end view of the magnetic field generating device assembly of FIG. 18;

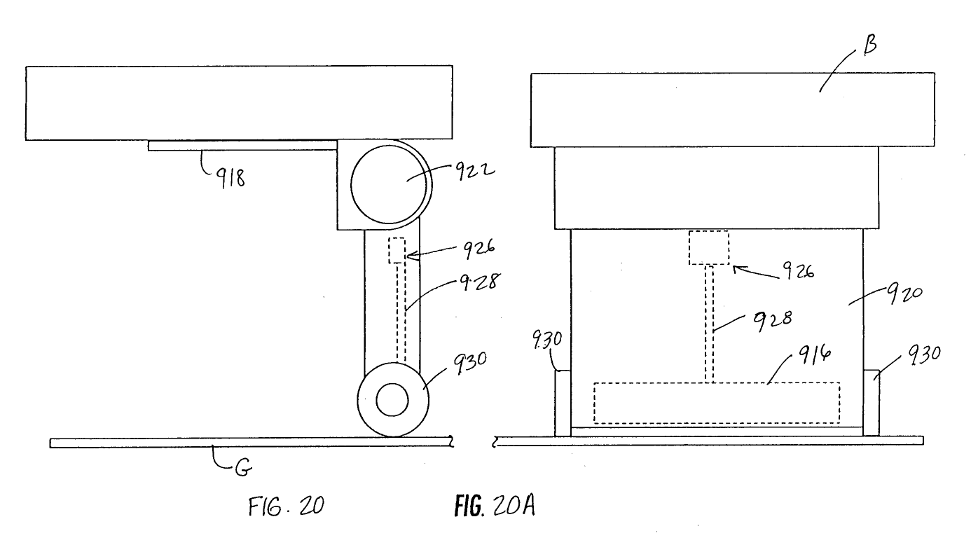

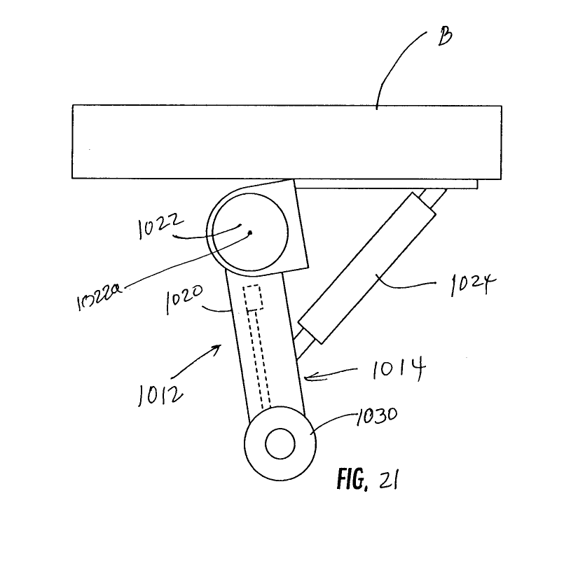

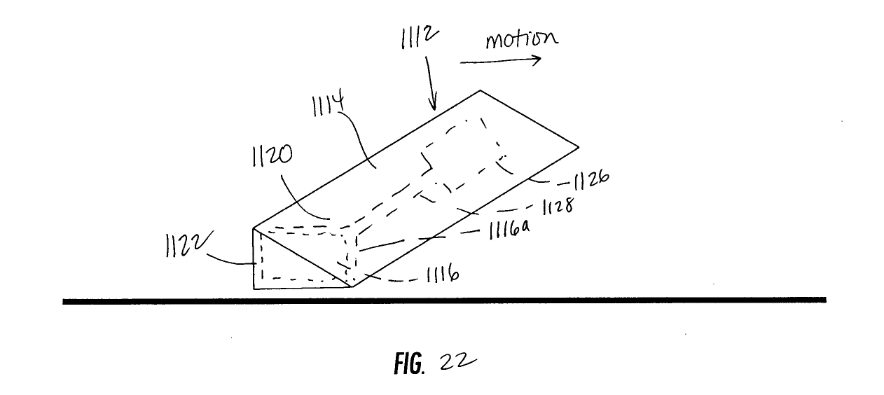

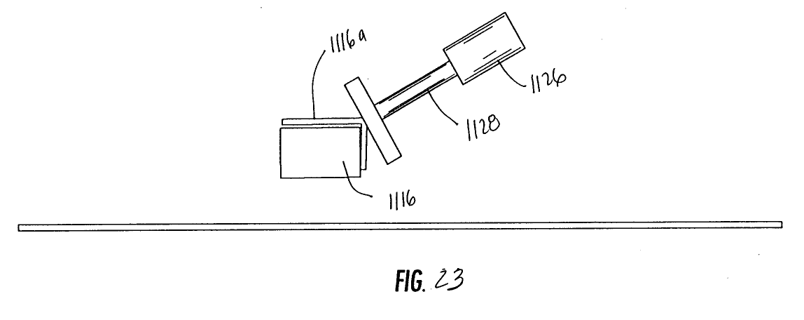

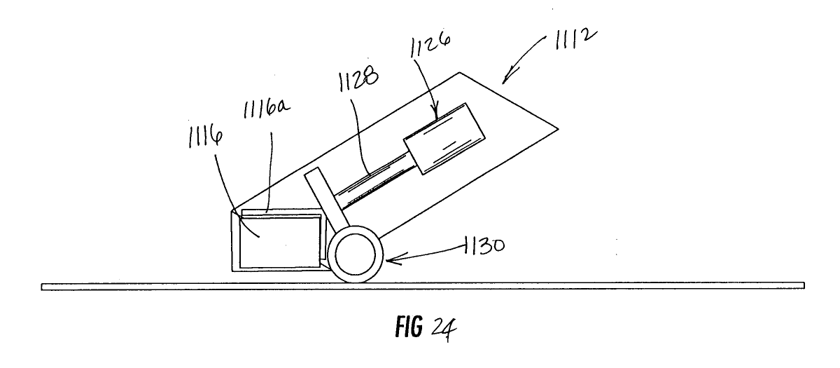

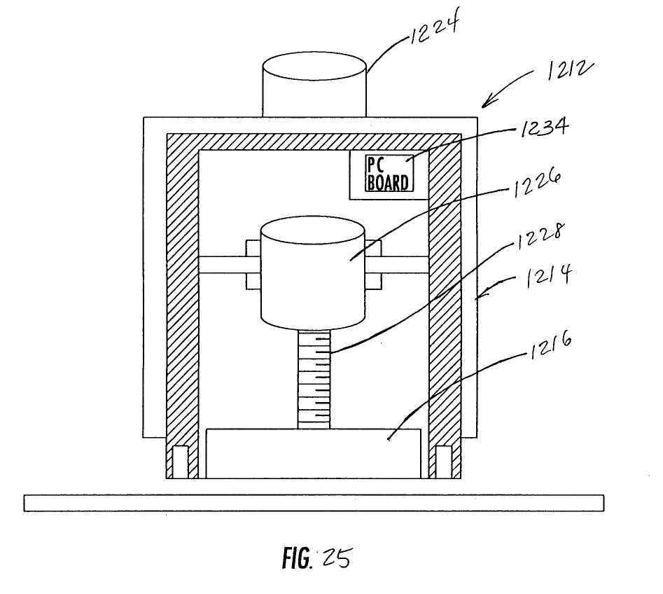

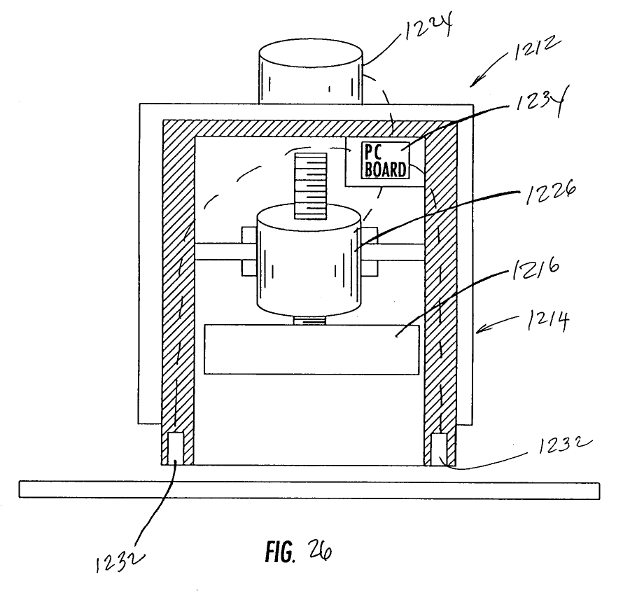

FIG. 20 is a similar view to FIG. 18 illustrating the lower portion of the housing incorporating a ground engaging member contacting a guide surface, such as a road surface;

FIG. 20A is an end view of the assembly of FIG. 20;

FIG. 21 is another embodiment of the magnetic field generating device assembly of the present invention;

FIG. 22 is a schematic view of another embodiment of the magnetic field generating device assembly of the present invention;

FIG. 23 is a similar view to FIG. 23 with the housing and wheel removed for clarity;

FIG. 24 is a side elevation view of another embodiment of the magnetic field generating device assembly of FIGS. 22 and 23 incorporating a ground engaging member for engaging a ground surface;

FIG. 25 is a schematic drawing of another embodiment of the magnetic field generating device assembly of the present invention;

FIG. 26 is a similar view to FIG. 25 with the magnetic field generator of the assembly shown in a retracted position;

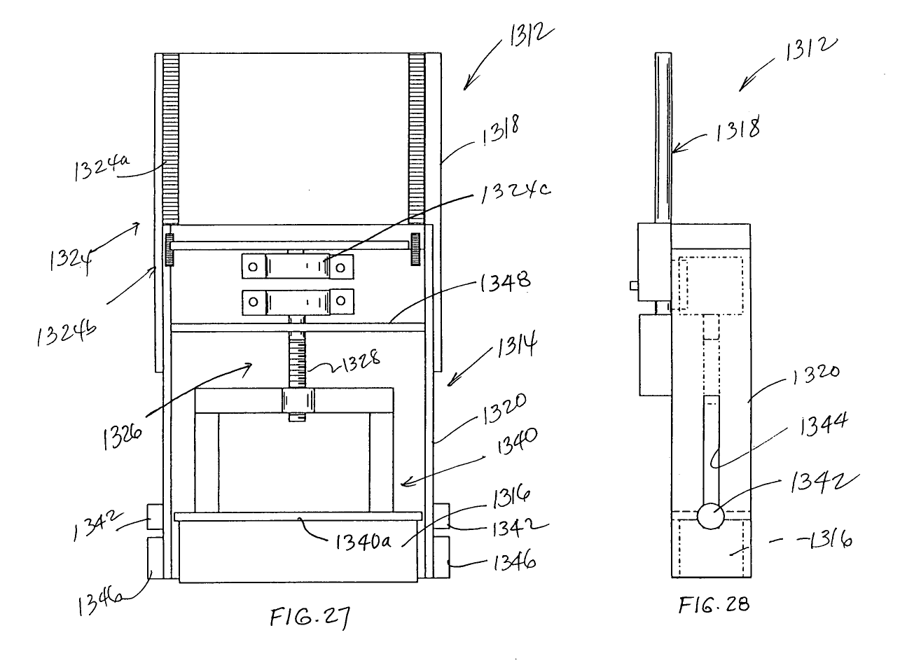

FIG. 27 is a schematic view of another embodiment of the magnetic field generating device assembly of the present invention;

FIG. 28 is a side elevation view of the assembly of FIG. 27;

FIG. 29 is a schematic view of another embodiment of the magnetic field generating device assembly of the present invention;

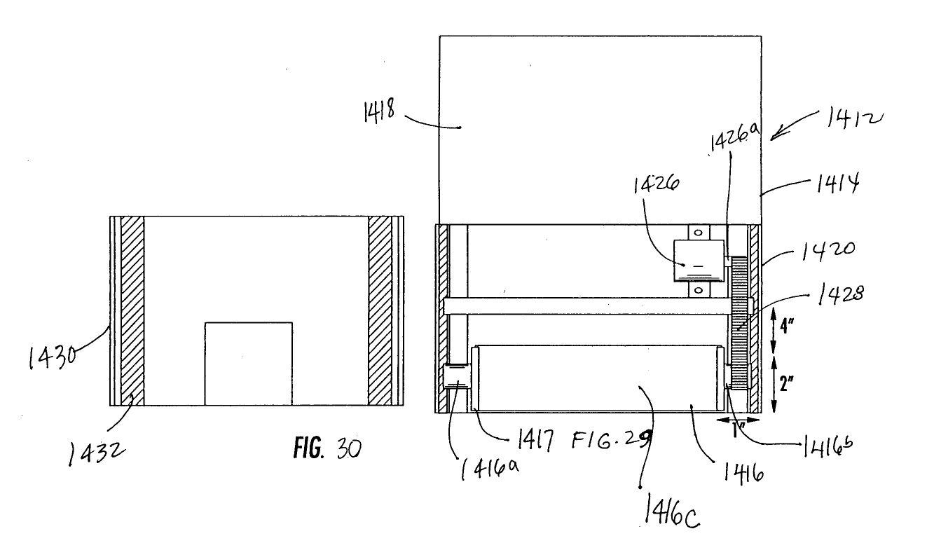

FIG. 30 is a side view of the assembly of FIG. 29;

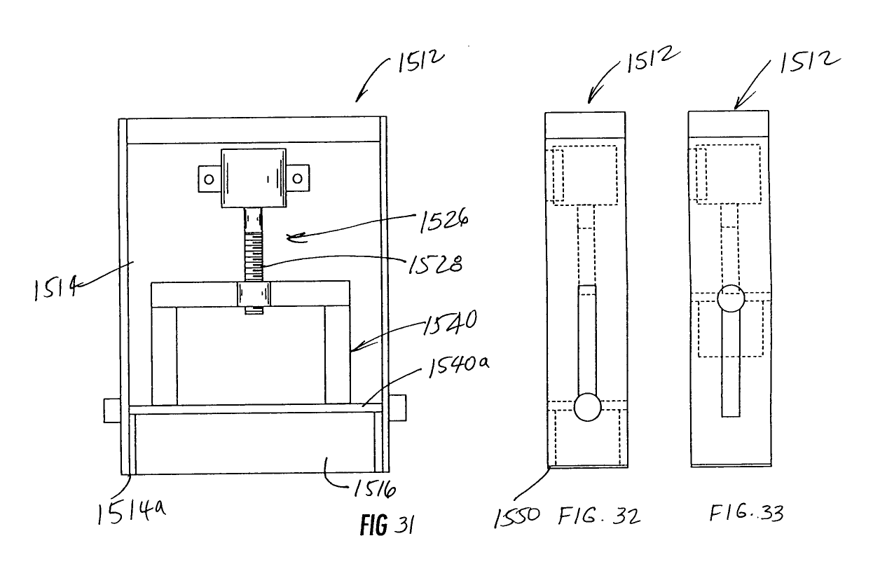

FIG. 31 is a schematic view of another embodiment of the magnetic field generating device assembly of the present invention;

FIG. 32 is a side elevation view of the assembly of FIG. 31 illustrating the magnetic field generator in an extended operative position;

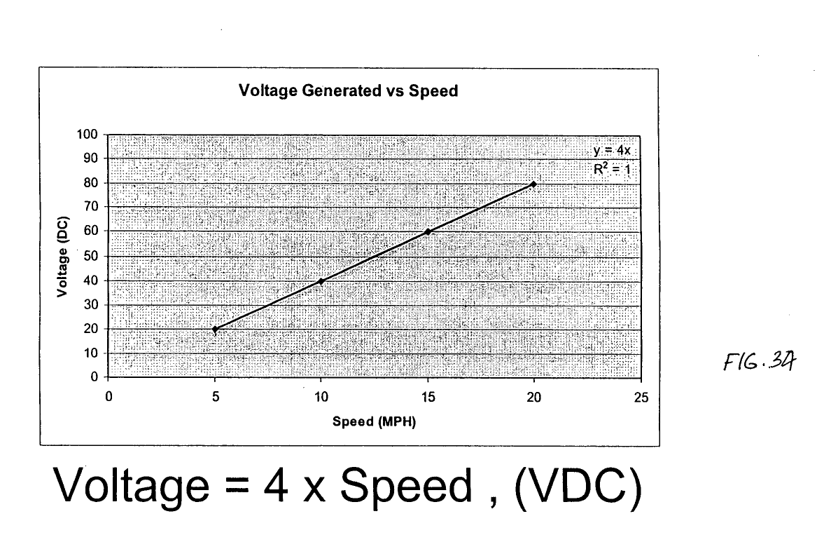

FIG. 33 is a similar view to FIG. 32 illustrating the magnetic field generator in a retracted position within the housing of the assembly; and

FIG. 34 is a graph illustrating the voltage versus speed of the vehicle generated by the magnetic field generating device passing over the conductor of the present invention.

### DETAILED DESCRIPTION OF THE PREFERRED EMBODIMENTS

Referring to FIG. 1, the numeral 10 generally designates an energy recovery system of the present invention. As will be more fully described below, the energy recovery system of the present invention uses the motion of a moving object to generate energy and/or resources that can be used immediately or stored for later use and, further, can optionally be delivered to a location remote from the object. For ease of description, hereinafter reference will be made to a vehicle as the moving object. However, it should be understood that the present invention is not so limited.

Energy recovery system 10 includes a magnetic field generator 12, a conductor 14, such as a bundle of electrically conductive wires, that forms a closed loop circuit, and an energy supply 16, including an energy storage device, such as a battery or a capacitor, which stores the energy generated by the current flowing through the circuit, or a transformer or inverter, which inverts the DC voltage to directly feed the grid. Magnetic field generator 12 may comprise a permanent magnet or an electromagnet and is mounted to vehicle V, such as a car, an SUV, a truck, a bus, a train, or the like. For example, magnetic field generator 12 may comprise a permanent magnet commercially fabricated from such materials as sintered and bonded Neodymium iron boron, or samarium cobalt, or alnico, or ceramics. The dimensions of the magnet depends on the vehicle size and the ultimate magnetic field strength desired at the conductor surface. One example is a permanent magnet of sintered and bonded Neodymium alloy that is 5.75 inches in width and a square cross sectional dimension of 1.93 inches by 1.93 inches. This permanent magnet example can deliver a field strength of approximately 2300 Gauss at a distance of one inch from its 5.75 inch surface facing the conductor. Higher magnetic strength permanent magnets can be designed but this field strength can generate approximately 10 amps of current at 120 volts A.C. in some alternating conductor circuit designs at vehicle speeds around 25 miles per hour.

Conductor 14 is located in the path of the vehicle so that when magnetic field generator 12 passes by conductor 14, current flow is induced in the conductor, which is transmitted to energy supply 16 for storage and later use, as will be more fully described below. As mentioned above, conductor circuits can be designed with a variety of objectives with respect to current and voltage generation. But basically they are either alternating or direct current circuits. The final conductor design will depend on the specific voltage and current desired and the method of storage and/or use of the generated electricity. For example, when hydrogen generation is desired then the desired conductor design should be direct current whereas for direct lighting an alternating current conductor circuit might be considered.

As generally noted above, magnetic field generator 12 is mounted to the vehicle so that when the vehicle is traveling and travels across or by conductor 14, magnetic field generator 12 will induce current flow in conductor 14. As noted below, magnetic field generator 12 may comprise a non-rotating magnetic field generator 12a or a rotating magnetic field generator 12b. According to Faraday's Law of Induction, when a magnet or conductor moves relative to the other, for example when a conductor is moved across a magnetic field, a current is caused to circulate in the conductor. Furthermore, when the magnetic force increases or decreases, it produces electricity; the faster it increases or decreases, the more electricity it produces. In other words, the voltage induced in a conductor is proportional to the rate of change of the magnetic flux. In addition, based Faraday's laws and Maxwell's equations, the faster the magnetic field is changing, the larger the voltage that will be induced. Therefore, the faster the vehicle moves past conductor 14, the greater the current flow and, hence, the greater amount of energy stored in the storage device or transmitted by the energy supply 16.

As is known from Lenz' law, when a current flow is induced in conductor 14 it creates a magnetic field in conductor 14, which opposes the change in the external magnetic field, produced by magnetic field generator 12. As a result, the forward motion of the vehicle will be slowed; though the degree to which the forward motion will be slowed will vary depending on the magnitude of the respective fields. In keeping with the goal to recover energy, therefore, conductor 14 is preferably located along the path of vehicle where the vehicle is the most inefficient (i.e. where the vehicle wastes energy) and also where the vehicle has the greatest speed. For example, conductor 14 may be located at a decline, such as on the downhill side of a hill or of a mountain or the like, where the vehicle's speed will increase under the force of gravity over the engine induced speed. On a decline where the speed of the vehicle has increased due to the force of gravity, drivers will often apply their brakes to slow the vehicle to maintain their speed within the speed limit. Ordinarily, the vehicle's engine will run continuously, thus wasting energy, which energy in the present system is recovered. Provided that the reduction in the speed of the vehicle due to the interaction between the two magnetic fields does not exceed the corresponding increase in speed due to gravity, the recovery of energy from the vehicle does not increase the energy consumed by the vehicle. Hence, energy that would otherwise be wasted is recovered from the vehicle. Though it should be understood that the conductor may be positioned at other locations along the path of the vehicle, including locations where the vehicles must begin braking or begin slowing down.

As noted above, conductor 14 preferably comprises a bundle of electrically conductive wires, which are placed in the path (or adjacent the path) of the vehicle. Preferably, the wires are extended across the path, for example across the roadway generally orthogonal to the direction of travel of the vehicle, so that the vehicle passes over the bundle of wires. More preferably, the wires may be incorporated below the road surface of the roadway. For example, the wires may be recessed or embedded in the roadway surface and, further, optionally encapsulated in a body that is recessed or embedded in the roadway. For example, the material forming the body for encapsulating the wires is preferably a non-conductive and/or non-magnetic material, such plastic or rubber or the like, to insulate the wires and to protect the wires from the elements, and road debris.

Referring again to FIG. 1, energy storage device 16 is coupled to a control system 18, which monitors and/or detects when energy storage device 16 has reached or exceeded a threshold level of stored energy. Preferably, control system 18 is configured to transfer energy from storage energy device 16 when the energy level in storage device 16 has reached the threshold level and, further, to transfer the energy to a transmission system or an energy conversion system or the like, where the transferred energy can be used as a supply of energy or to generate resources for some purpose other than driving the vehicle.

For example, control system 18 may transfer the energy to an energy conversion system 20 to transform the energy into another resource, such as a supply of oxygen, hydrogen, or other consumable products. Furthermore, one or more of these products may in turn be used to generate more energy as noted below. In the illustrated embodiment energy conversion system 20 includes an electrolysis system 22 that uses the transferred energy to convert, for example, water into oxygen and hydrogen, which oxygen may be forwarded on to laboratories or hospitals or the like. As noted above, the hydrogen may be used as an energy transfer fuel. Hydrogen may be used as fuel and an energy supply, including to power vehicles, run turbines or fuel cells, which produce electricity, and to generate heat and electricity for buildings. In the illustrated embodiment, the hydrogen is used to run hydrogen fuel cells 23, which convert hydrogen and oxygen into electricity and can be used to power other vehicles or to provide electricity and heat to buildings. Hence, the current flow in conductor 12 may be used to generate energy and/or to produce products.

As noted above, magnetic field generator 12 may comprise a permanent magnet or an electromagnet. When employing an electromagnet, the magnetic field may be selectively actuated. For example, the vehicle may include a control for actuating the electromagnet. Further, energy recovery system 10 may include a sensor 24 that generates a signal to the vehicle control when the sensor detects that the vehicle is in proximity to conductor 14 so trigger the control to actuate the electromagnet. Sensor 24 may be mounted to the vehicle or may be mounted at or near the conductor.

Referring to FIG. 2, the numeral 30 generally designates a vehicle. Although vehicle 30 is illustrated as an automobile, it should be understood that the term vehicle as used herein is used in its broadest sense to cover any means to carry or transport an object and includes trains, buses, trucks, bikes, or even an airplane, or the like. As noted above, the faster the speed of the magnetic field generator 12, the greater the rate of energy generation. FIG. 2 illustrates two alternative magnetic field generators—one (12a) mounted to the underside of the car, for example near or under the rear bumper, and another (12b) mounted to the wheel, for example in the hub of the wheel 32 so that it rotates with the wheel. Alternately, the magnetic field generator may be mounted to a flywheel or the like, for example, that is driven by the vehicle engine.

In preferred form, the negative (N) poles of the rotating magnetic field generator 12b are facing outwardly from the center of the wheel device, so that the poles would be traveling at a higher speed than if mounted at a fixed location on the vehicle. Thus, when the vehicle drives over or adjacent the conductor (14), the rate of rotation of the magnetic field generator 12b would significantly increase the rate of electricity generation per pass over or by adjacent the conductor. This same increased energy generation can be used with the magnetic field generator being mounted to a train wheel device.

Furthermore, the rotating magnetic field generator 12b may also comprise a cylindrical structure formed from a plurality of permanent magnets, with one pole oriented towards the perimeter of the cylindrical-shaped member and the other pole being oriented towards the center of the cylindrical-shaped member. This will ensure conservation of Lens' law for induced current directionality within the conductor.

Similarly, magnetic field generator 12a may be formed from a single magnet or from a plurality of magnets. For example, a single large magnet may be mounted to the vehicle. Exemplary dimensions could include a 2″×8″×2″ magnet. Alternately, as noted, a plurality of smaller magnets can be mounted. For example, four 2″×2″×2″ magnets may be used in lieu of the a 2″×8″×2″ magnet. It should be understood, however, that the size and number of magnets may be varied depending on the particular application.

When multiple magnets are provided the magnets are preferably arranged in the same plane and optionally located in close proximity to each other. They may be arranged in a side by side configuration where the amplitude of the electric wave induced by each magnet is additive. Alternately, the magnets may be aligned along a common axis that is aligned with the direction of travel and with their North poles, for example, all facing in the same direction, either all facing in the direction of travel or all facing in an opposed direction from the direction of travel of the vehicle. The magnets may be arranged so that they are abutting each other, for example, each with its N poles oriented in the same direction, for example in the direction of travel. In this manner, when the first magnet passes over the conductor, the first magnet will generate an electric wave in the conductor. The next magnet will similarly generate an electric wave in the conductor, but the electric waves generated by the magnets will have a slight delay.

In another arrangement, the magnets may be staggered and aligned along parallel axes also aligned along the direction of travel. With this arrangement the magnets may be arranged so that the electric waves generated by the magnets overlap so that they are additive to form an electric wave with an increased phase. Consequently, this staggered arrangement prevents the generated electric wave from collapsing to zero, which results an increase in the generated power.

Referring to FIG. 3, the numeral 114 generally designates a conductor of the present invention. In the illustrated embodiment, conductor 114 includes a plurality of conductor modules 140 that are arranged to form a DC circuit 142 across which magnetic field generator 12 passes when mounted to a vehicle to induce the current flow through circuit 142. Circuit 142 may be coupled, as previously described, to an energy supply 16, such as an energy storage device or a transformer or an inverter for directly transmitting the voltage to, for example, a grid. For example, the energy storage device may comprise a bank of capacitors that can be used to connect to a grid and can be used to make hydrogen, as previously described. Also it can be connected to a switch capacitor circuit that reduces, if not eliminates, the load variation on a generator to which the energy recovery system may be coupled due to the variation in the power usage at the end load. Switching capacitor circuits are well known and typically include at least two capacitors and a logic controller that is coupled to the generator and to the capacitors and selectively switches between the two capacitors. A second controller is coupled to first controller through the capacitors. An inverter couples the second controller to the end load. The first controller switches between the two capacitors when one of the capacitors reaches saturation. In this manner, the generator is isolated from the variation in load at the end load.

Each module 140 comprises a plurality of conductive wires arranged in loops with each module connected in series to form a DC circuit. In the illustrated embodiment, conductor modules 140 are positioned and preferably encapsulated in a slab 144, such as a prefab slab. For example, slab 144 may be made of concrete or polymeric materials or a composite material and, further, is adapted to embedded in a road surface such that the upper surface 144a of the slab is substantially contiguous and planar with the upper surface of the road surface S.

Referring to FIG. 4, each conductor module 140 comprises a plurality of conductive wires 146, such as copper wires, which are arranged in adjacent loops about a frame 148. For example, a suitable conductive wire includes copper wire, for example a 10-gauge copper wire. Frame 148 forms upper and lower raceways 150 and 152 through which the wires are looped. Further, frame 148 preferably includes a pair of side walls 154 and 156 and a central or core member 158 which together form the upper and lower raceways and retain the wires in the frame. Side walls 154, 156 and member 158 are each formed from a non-conductive material, such as a polymer, including a reinforced polymer, wood, or a composite material.

As best seen in FIGS. 4, 5, and 5A, frame 148 may include a magnetic shield 160, which is located between the upper and lower raceways, to block the magnetic field 162 generated by magnetic field generator 12 from interfering with the current flow in the lower run of the wires as they pass through the lower raceway. In the illustrated embodiment, magnetic shield 160 comprises a metal plate, which is positioned below member 158 but above the lower run of wires 146. For example, a suitable metal plate includes a sheet of steel or nickel with a thickness, for example on the order of 0.03 inches. As would be understood by those skilled in the art, the voltage generated at energy supply 16, such as the storage device, is a function of the speed or the vehicle and the number and length of each loop.

Referring to FIGS. 5 and 5A, as noted above, frame 148 is formed from a pair of side walls 154 and 156 and a member 158, which interconnects walls 154 and 156 forms a core for frame 148 about which the wires are wound. Member 158 terminates inwardly of the outer ends 154a, 154b and 156a, 156b of side walls 154 and 156 to provide a passageway between upper and lower raceways 150 and 152 so that when the wires 146 are wrapped around core 158, the wires will be substantially retained in frame 148. Further, as best seen in FIG. 5, magnetic shield 160 preferably extends substantially the full length of core member 158 to thereby provide a magnetic shield over substantially the full length of the upper and lower raceways.

Referring to FIGS. 6 and 6A, wires 146 are preferably arranged are arranged in frame 148 in multiple layers 146a and rows 146b. For example, suitable wire bundles may have a width of 3 inches, length of 24 inches, and depth of 1.5 inches. It should be understood that these dimensions are exemplary only and are not intended to limit the scope of the invention, which will vary considerably based on the specific application of the present invention.

Referring the FIGS. 7 and 8, the numeral 214 designates another embodiment of the conductor of the present invention. Conductor 214 comprises a plurality of nested loops of conductive wires 246, such as copper wires, which are arranged to form a DC circuit. In the illustrated embodiment, the loops are formed from wire sections that are interconnected by electrical connectors 247. Further, the loops may be bundled together by connectors 248. As would be understood, the number and lengths of the loops may vary depending on the application. As noted, wires 246 are arranged to form a DC circuit 242 for coupling to energy supply 16, such as a storage device. Referring to FIG. 8, it can be appreciated that the wires need not necessarily be bundled, which eliminates the need for connectors 248.

Referring to FIG. 9, the numeral 314 designates yet another embodiment of a DC version of the conductor of the present invention. Similar to conductor 114, conductor 314 incorporates a plurality of conductor modules 340 that are embedded in a slab 344. Though it should be understood that the conductor may be formed from individual wire loops that are embedded in slab 344.

In the illustrated embodiment, conductor 314 includes two groups of conductor modules or loops with one group of conductor modules 340a being embedded in slab 344 and with the second group of conductor modules or loops 340b being arranged out of slab 344, for example, generally perpendicular to the first set of conductor modules or loops. Further, connector modules or loops 340b may be arranged in the manner to form a passageway 350 to allow, for example, the moving object to pass through the passageway to thereby induce current flow through both groups of conductor modules or loops 340a and 340b. For example, loops or modules 340b may be mounted in a toll booth, a stop light frame or to a bridge, where the wires extend over the car.

Referring to FIG. 10, another embodiment of a DC conductor 414 is illustrated wherein the wire loops 416 are horizontally staggered and, further, bundled together by connectors 448. Similarly, each loop may be formed from wire sections that are electrically interconnected by electrical connectors 447.

Referring to FIG. 11, the numeral 515 refers to another embodiment of the conductor of the present invention. Conductor 515 includes a plurality of conductor modules 540, such as described in reference to FIGS. 4-6A, which are electrically interconnected by a circuit 542. Each module 540 is coupled to a circuit through a diode 544 so that each conductor module 540 acts individually and independently delivers current to circuit 542, which in turn is preferably coupled to a load controller energy storage device 546.

Referring to FIG. 12, the numeral 640 designates another embodiment of a conductor module formed from a plurality of conductor sub-modules 642. Sub-modules 642 are arranged in a common plane, with each sub-module 642 being formed from a plurality of looped conductive wires, such as copper wires, which may be interconnected by leads 642a to form a DC circuit. By providing sub-modules, the size of each module 640 may be increased or decreased by simply adding additional sub-modules or removing sub-modules.

Referring to FIG. 13, conductor 714 comprises an AC conductor that is formed from a plurality of looped conductive wires 746 that are arranged to form an AC circuit. Referring to FIG. 14, wire loops 746 may be arranged and located in slab 744 and, further, may be arranged in a common plane. Further, slab 744 may include a plurality of conductors 714 that are arranged in slab 744 and with each conductor 714 coupled to energy supply 16.

Referring to FIGS. 15-17, the numeral 812 designates a magnetic field generator assembly. Magnetic field generator assembly 812 is particularly suitable for mounting to a vehicle, particularly, to the body of a vehicle and, more particularly, to the body of a car. As noted in reference to FIG. 2, one suitable location is at the rear of the car, for example, near or at the rear bumper.

As best understood in FIGS. 15 and 17, magnetic field generator device assembly 812 includes a housing 814 and a magnetic field generator 816, such as a magnet—either a permanent magnet or an electromagnet. Further, as in the case of any of the embodiments described herein, magnetic field generator device assembly 816 may incorporate a single magnet or multiple magnets as described previously.

Housing 814 includes a mounting portion 818, which is mounted to body B by conventional means, for example by fasteners, such as threaded fasteners, bolts, or rivets, or by welding, and a movable portion 820. Movable portion 820 is pivotably mounted to mounting portion 818 by a hinge 822, which provides pivotal movement about a horizontal axis 822a. Hereinafter, reference will be made to magnet 816, though it should be understood that other magnetic field generating devices may be used. Magnet 816 is located in movable portion 820, which is moved between a stowed position as shown in FIG. 15 and an operative, extended position as shown in FIG. 17 so that magnet 816 can be moved to a position in close proximity to the conductor, for example as shown in FIG. 4.

Housing 814 may be formed from a variety of different materials including plastic or other non-magnetic materials, such as aluminum, steel, or nickel, and preferably forms a shroud around magnet 816. Further, end 814a of housing 814 may be open or closed by a cover, which is formed from a non-conductive material so as not to interfere with the magnetic field of magnet 816.

Hinge 822 may be driven about axis 822a by a driver mechanism, such as rotary motor 824 (FIG. 16), which may be controlled by the operator of the vehicle or may be controlled by a control system, described more fully below. Although illustrated as being at least partially external to housing 814, motor 824 may be mounted in housing 814. As described in reference to the later embodiments, assembly 812 may incorporate a proximity sensor, which communicates with a control system provided on the vehicle or in the magnetic field generator assembly, to detect when the vehicle approaches the conductor and, further, generates signals, which are either detected by or sent to the control system, to actuate motor 824 when the vehicle approaches or is in close proximity to the conductor.

Again, referring to FIGS. 15 and 17, magnet 816 may be movably mounted within the housing 814. For example, magnet 816 may be moved by a second driver mechanism, such as drive motor 826, which is also housed in housing 814. Motor 826 includes a drive rod 828 to which magnet 816 is optionally mounted and which extends and contracts to move the magnet 816 between a retracted position within the housing to an extended position, still preferably within the housing but adjacent or at lower end 814a of housing. Optionally, though not illustrated, magnet 816 may be extended to at least partially project from housing 814. This may be suitable when the end of housing is open, with the magnet movement providing a self-shedding function to shed assembly 812 of debris that could potentially accumulate in housing 814 through open end 814a.

Referring to FIGS. 18-20A, the numeral 912 designates another embodiment of the magnetic field generator device assembly of the present invention. Assembly 912 is of similar construction to assembly 812 and includes a housing 914 and a magnetic field generator, such as magnet 916. Housing 914 similarly includes a mounting portion 918 and a movable portion 920, which is movably mounted to mounting portion 918 by a hinge 922. Hinge 922 is similarly driven by a driver mechanism, such as rotational motor 924. For further details of assembly 912, reference is made to the previous embodiment.

In the illustrated embodiment, assembly 912 further includes a pair of ground engaging elements or wheels 930, which mount to both sides of movable portion 920 (see FIG. 20A) for optionally engaging the ground surface G when movable portion 920 of housing 914 is moved to its operative or extended position. Wheels 930 are preferably mounted to housing by springs to permit the wheels to absorb variations in the surface topology of the surface on which the wheels are driven.

Referring to FIG. 21, the numeral 1012 generally designates yet another embodiment of the magnetic field generating device assembly of the present invention. Assembly 1012 is similar to the previous embodiments (and, therefore, reference is made thereto); however, movable portion 1020 is moved about hinge 1022 and axis 1022a by an extensible driver mechanism, such as a cylinder 1024, which is extended (or contracted) to thereby move the movable portion 1020 between an extended position and a retracted position. Similar to assembly 912, assembly 1012 includes a ground engaging elements 1030, such as wheels, which are mounted at a lower end of movable portion 1020 of housing 1014.

Cylinder 1024 may comprise a hydraulic or pneumatic cylinder, including a gas operated cylinder, which may be similarly actuated to contract or extend by a control system described more fully below. Cylinder 1024 may provide a shock absorbing function to eliminate the need for or supplement the springs that mount wheels 1030 to housing 1014.

Referring to FIG. 22, the numeral 1112 generally designates another embodiment of the magnetic field generating device assembly. Assembly 1112 includes a housing 1114 which houses a magnetic field generator, such as a magnet (shown in phantom, but see FIG. 23). Housing 1114 includes a movable portion 1120, which houses the magnet, and a mounting portion (not shown), which mounts the movable portion to the underside of a vehicle, for example. In the illustrated embodiment, housing 1114 comprises a trapezoidal-shaped housing with a triangular-shaped lower end 1122 which provides a shroud around the magnet 1116 when the magnet is in its extended position. Magnet 1116 is mounted in housing 114 on a bracket 1116a, which mounts magnet 1116 to an extensible shaft 1128 of motor 1126 so that the magnet can be retracted within housing 114 in a similar manner to the previous embodiments.

Referring to FIG. 24, assembly 1112 is provided with a pair of ground engaging members 1130, such as wheels. As described in reference to the previous embodiment, it may be preferable to mount ground engaging member 1130 by springs to the housing 1114 to provide a shock absorbing function.

Referring to FIG. 25, the numeral 1212 designates yet another embodiment of the magnetic field generating device assembly of the present invention. Similar to the previous embodiments, magnetic field generating device 1212 includes a housing 1214 and a magnetic field generator, such as magnet 1216, which is movably mounted within housing 1214 by a motor 1226. Housing 1214 is similarly mounted to the underside of the vehicle and preferably mounted in a manner to permit housing 1214 to move between an operative position, such as shown in FIG. 25, and a stowed position wherein the housing 1214 is closer to the vehicle. Similar to the previous embodiments, assembly 1212 includes a motor 1224 for moving the housing 1214 to its retracted position about a pivot axis, such as the horizontal pivot axis similar described in reference to the previous embodiments. For further details for suitable mounting arrangements, reference is made to the previous embodiments.

In the illustrated embodiment, motor 1226 includes a screw drive motor with magnet 1216 mounted at the end of the screw drive shaft 1228. In this manner, as shaft 1228 is rotated by motor 1226, magnet 1216 will be retracted into housing 1214.

As previously noted, assembly 1212 may incorporate a pair of sensors 1232, such as proximity sensors, which detect when the vehicle is in close proximity to the conductor. Further, in the illustrated embodiment, assembly 1212 incorporates a circuit board 1234, which is in communication with sensors 1232, motor 1226, and also optionally with motor 1224 to thereby control the position of the magnet and, further, the position of the housing. Circuit board 1234 optionally incorporates a microprocessor or may be in communication with a microprocessor on board the vehicle. For example, the microprocessor may be configured to receive signals from or detect the state of sensors 1232 and upon detecting or receiving a signal indicative of the close proximity of the vehicle to the conductor, generates actuating signals to motor 1226 to drive motor and thereby move magnet 1216 from its retracted position or home position within housing 1214 to its extended or active position as shown in FIG. 25. Further, prior to or simultaneous to moving magnet 1216, the microprocessor may likewise upon sensors 1232 detecting proximity of the conductor, may actuate motor 1224 to move housing 1214 between its retracted or home position to its extended or operative position. These functions can be performed at the same time, as noted, or may have a built-in delay. As would be understood, any of the embodiments described herein may incorporate the same or similar control system. Further, at least part of the control system may be incorporated into the magnetic field generating device assembly as noted above or may be external to the magnetic field generating device assembly and mounted, for example in the vehicle. It should be understood that additional functions and features may be added.

Referring to FIGS. 27-28, the numeral 1312 designates yet another embodiment of the magnetic field generating device assembly of the present invention. Assembly 1312 includes a housing 1314, which includes a fixed portion 1318 that mounts to the underside of the vehicle, and a movable portion 1320. In the illustrated embodiment, movable portion 1320 is moved in a linear motion relative to mounting portion 1318 and is driven by a rack and pinion drive assembly 1324. For example, rack 1324a may be mounted in housing portion 1318 while pinions 1324b and motor 1324c, which drives the pinions, may be mounted in movable portion 1320. It should be understood that the components may be reversed, however.

Similar to the previous embodiment, magnet 1316 is movably mounted in movable portion 1320 and, further, driven by a screw drive assembly 1326. In addition, magnet 1316 is mounted to screw 1328 by a frame 1340 which is guided in movable portion 1320 by a pair of pins 1342 that protect through the wall of movable portion 1320 and are guided in an elongate slot 1344. Frame 1340 is preferably formed from a non-magnetic material, and, further, preferably from a light-weight non-magnetic material, such as aluminum. Magnet 1316 is mounted to frame 1340 by a non-magnetic plate, such as a steel plate. Optionally, magnet 1316 may be mounted to plate 1340a, for example, by an adhesive or the like.

In addition, assembly 1312 includes proximity sensors 1346, which are similarly provided to detect when the vehicle is in close proximity to the conductor. For further details of the use of proximity sensors 1346, reference is made to the previous embodiments.

As would be understood from the previous description, when motor 1324c is actuated, movable portion 1320 will translate relative to mounting portion 1318 between a retracted position when movable portion 1320 is closer to the vehicle and an extended position as shown in FIG. 27. Further, when the motor of rack and pinion assembly 1326 is actuated, frame 1340 will be translated within movable portion 1320. Optionally, movable portion 1320 includes a plate barrier 1348, which may be formed from steel delrin, which prevents the magnetic field generated by magnet 1316 from extending through the entirety of housing 1314 and, further, to limit any potential interference with systems within the vehicle.

Referring to FIGS. 29 and 30, the numeral 1412 designates another embodiment of the magnetic field generating device assembly of the present invention. Assembly 1412 similarly includes a housing 1414 and a magnet 1416, which his housed in housing 1414. In the illustrated embodiment, magnet 1416 is mounted in housing 1414 by a pair of trunnions 1416a and 1416b, which are rotatably mounted in the wall of housing 1414. Similar to the previous embodiments, housing 1414 includes a mounting portion 1418 and a lower portion 1420, which houses magnet 1416. Located in lower portion 1420 is a motor 1426, which rotates magnet 1416 by a drive belt 1428, such as a cog belt, which extends about the motor shaft 1426a and trunnion 1416b that rotatably mount magnet 1416 in housing 1414.

In the illustrated embodiment, lower portion 1420 of housing 1414 includes an exterior non-conductive wall or plate 1430, such as steel, and an inner plate or wall 1432, which is formed from delrin. Trunnions 1416a and 1416b are rotatably supported in plate 1432, wherein plate 1432 forms a non-magnetic shroud around magnet 1416.

As noted above, magnet 1416 is supported in housing 1414 by a pair of trunnions 1416a and 1416b. In the illustrated embodiment, trunnions 1416a and 1416b are attached to a housing 1417, which supports magnet 1416. For example, a suitable material for housing 1417 is aluminum. Optionally, housing 1417 may enclose at least three sides of the magnet to provide a single magnetic surface 1416c that can be rotated or moved between a non-operative position such as shown in FIG. 29 wherein the magnetic surface is rotated so that it faces into the housing and an operative position wherein the magnetic surface 1416c is rotated to face outwardly from housing 1414. Again, with this arrangement the reach of the magnetic filed generated by the magnet may be restricted to minimize interference with systems in the vehicle.

Referring to FIGS. 31-33, the numeral 1512 designates yet another embodiment of the magnetic field generating device assembly of the present invention. Assembly 1512 includes a housing 1514 and a magnet 1516, which is movably mounted in housing 1514 by a screw drive assembly 1526, with magnet 1516 preferably mounted to the screw drive rod 1528 by frame 1540 similar to assembly 1312. Similar to assembly 1312, magnet 1516 is mounted to a non-conductive plate 1540a, which mounts magnet 1516 to frame 1540. Further, in the illustrated embodiment, assembly 1512 includes a cover 1550 at open end 1514a of housing 1514. A suitable cover, as previously noted, should be non-conductive and not interfere with the magnetic field generated by magnet 1516 and may comprise, for example, a plastic cover.

Referring to FIG. 34, as it would understood by those skilled in the art, the voltage generated by the energy recovery system of the present invention linearly increases with the speed of the object or vehicle to which the magnetic field generating device or magnetic field generating device is mounted. For example, for a speed of 5 miles per hour, a DC voltage of 20 volts was obtained. Similarly, for 10 miles per hour speed, a DC voltage of 40 volts was obtained. For 15 miles per hour, a DC of 60 volts was obtained. For 20 miles per hour, a DC of 80 volts was obtained.

Although described in reference to the magnetic field generating device mounted to the vehicle and the conductor located exteriorly of the vehicle, the magnetic field generating device may be mounted exteriorly of the vehicle with the conductor located in the vehicle. For example, this variation may have a particularly suitable application in a hybrid vehicle where electricity is used to run the vehicle over a range of the vehicle speed where the vehicle's battery or batteries require recharging on a regular basis. With this configuration, the conductor may form a closed circuit with the battery (or batteries) to recharge the battery (or batteries) at least when the vehicle is passing over or by the magnetic field generating device. Similar to the conductors described above, the magnetic field generating device may comprise one or more magnets that are mounted either adjacent to or in the path of the vehicle. Further, the magnet or magnets may be mounted on or in the road surface and may be mounted at or in the road surface in a housing or embedded in a slab, such as concrete slab or polymer slab.

While several forms of the invention have been shown and described, other forms will now be apparent to those skilled in the art. For example, multiple magnetic field generators or multiple magnetic field generator assemblies may be used in any of the aforementioned applications to thereby further enhance the energy recovery. When this system is employed on a train, each train car could include one or more magnetic field generators or magnetic field generator assemblies so that as each car passes the conductor or conductors, which are preferably located near the track, energy can be generated from each magnetic field generator. While several forms of driver mechanisms have been described, other driver mechanisms may be used, such as servo motors, and the driver mechanisms may be combined with other load transmitting members, such as linkages or the like. Further, any feature of one embodiment may be combined with features of other embodiments. Therefore, it will be understood that the embodiments shown in the drawings and described above are merely for illustrative purposes, and are not intended to limit the scope of the invention, which is defined by the claims, which follow as interpreted under the principles of patent law including the doctrine of equivalents.

The embodiments of the invention in which an exclusive property right or: privilege is claimed are defined as follows:

1. An energy recovery system comprising:
a magnetic field generating device generating a magnetic field; and
a conductor, one of said magnetic field generating device and said conductor being adapted to a mount to a vehicle and the other one of said magnetic field generating device and said conductor being adapted for placing in or adjacent the path of the vehicle wherein said magnetic field induces current to flow through said conductor when the vehicle moves past said other one of said magnetic field generating device and said conductor.

2. The energy recovery system according to claim 1, further comprising a housing adapted to mount to a vehicle, said magnetic field generator device mounted in said housing; and wherein said conductor comprises a stationary conductor adapted for placing in or adjacent the path of the vehicle wherein said magnetic field induces current to flow through said conductor when the vehicle moves past the conductor, and said housing being adapted to move between an operative position wherein said magnetic field generator device is in relatively close proximity to said conductor and a retracted position closer to the vehicle to reduce the likelihood of impact with the housing.

3. The energy recovery system according to claim 1, wherein said magnetic field generating device comprises a magnet.

4. The energy recovery system according to claim 2, further comprising a vehicle, said housing mounted to said vehicle.

5. The energy recovery system according to claim 4, further comprising a sensor and a driver mechanism for selectively moving said housing, said sensor sensing when said housing is in proximity to said stationary conductor.

6. The energy recovery system according to claim 5, further comprising a control system, said control system including said sensor and generating a drive signal to said driver mechanism to move said housing to said operative position when said sensor senses said vehicle is in proximity to said stationary conductor.

7. The energy recovery system according to claim 5, wherein said housing includes a second driver mechanism for retracting said magnet in said housing.

8. The energy recovery system according to claim 2, wherein said stationary conductor comprises a plurality of loops of conductive wires.

9. The energy recovery system according to claim 8, wherein said conductive wires are mounted in a frame, said frame having an upper raceway and a lower raceway, said wires extending through said upper and lower raceways.

10. The energy recovery system claim 9, wherein said upper raceway is separated from said lower raceway by a magnetic shield.

11. The energy recovery system claim 10, further comprising a metal shield between said upper and lower raceway, said metal shield forming said magnetic shield.

12. The energy recovery system claim 9, wherein said frame comprises a generally H-shaped frame.

13. An energy recovery system comprising:
a vehicle;
a magnetic field generating device producing a magnetic field, said device mounted to said vehicle; and
a circuit, said circuit including a stationary conductor adapted for placing in or adjacent the path of said vehicle when the vehicle is moving wherein said magnetic field induces current to flow through said circuit when said vehicle passes by said conductor, and said device configured to move between an operative position wherein said magnetic field is in close proximity to said circuit and a stowed position wherein said device is moved closer to the vehicle.

14. The energy recovery system according to claim 13, wherein said conductor comprises a plurality of loops of conductive wires.

15. The energy recovery system according to claim 14, wherein said wires are mounted in a frame.

16. The energy recovery system according to claim 15, wherein said frame is configured for being mounted in a road surface.

17. The energy recovery system according to claim 14, wherein said wires are mounted in a slab of concrete, said slab being configured for being mounted in a road surface.

18. The energy recovery system according to claim 14, wherein at least some of said loops define a passageway, when said vehicle passes through said passageway, said magnet field inducing current flow through said wires.

19. The energy recovery system according to claim 13, wherein said circuit is coupled to a load controller.

20. The energy recovery system according to claim 13, wherein said circuit forms a DC circuit.

21. The energy recovery system according to claim 13, wherein said circuit forms an AC circuit.

22. The energy recovery system according to claim 13, wherein said circuit includes an energy storage device.

23. The energy recovery system according to claim 22, wherein said energy storage device is selectively coupled to an energy conversion system.

24. The energy recovery system according to claim 13, wherein said magnetic field generating device includes a plurality of magnets.

25. The energy recovery system according to claim 24, wherein said magnets are arranged in close proximity to each other wherein the electric waves induced in the stationary conductor by said magnets are additive.

26. The energy recovery system according to claim 25, wherein said magnets are arranged in a staggered arrangement with one magnet of said magnets offset relative to a second magnet of said magnets along the direction of travel of the vehicle wherein the generated electric waves from said one magnet and said second magnet additive and do not collapse to zero until after said second magnet passes by said stationary conductor.

27. A method of recovering energy comprising:
movably mounting a magnetic field generating device to a vehicle;
providing a stationary conductor external to the vehicle in the path of the vehicle;
moving the magnetic field generating device between a stowed position and an operative position where the magnetic field generating device is in close proximity to the conductor wherein the magnetic field generated by the device generates current flow in the conductor when the vehicle travels past the conductor.

28. The method of recovering energy according to claim 27, further comprising coupling the conductor to at least one chosen from an energy storage device, a transmission system, and an energy conversion system.

29. The method of recovering energy according to claim 27, wherein said providing a stationary conductor includes locating the conductor in a road surface.

30. The method of recovering energy according to claim 27, further comprising a driver mechanism for moving the magnetic field generating device between the operative position and the stowed position.

31. The method of recovering energy according to claim 30, further comprising sensing when the vehicle is in proximity to the conductor and actuating the driver mechanism to move the magnetic field generating device to its operative position when the sensing detects that the vehicle is in proximity to the conductor.

32. The method of recovering energy according to claim 27, further comprising housing the magnetic field generating device in a housing and mounting the housing to the vehicle.

33. The method of recovering energy according to claim 32, further comprising movably mounting the housing to the vehicle wherein the housing can be moved between an extended position wherein the magnetic field generating device is its operative position and a stowed position.

34. The method of recovering energy according to claim 32, further comprising moving the magnetic field generating device in the housing to move the magnetic field generating device between its operative position and its stowed position.
